(19) United States
(12) Patent Application Publication
(10) Pub. No.: US 2026/0311531 A1
(43) Pub. Date: Oct. 8, 2026

(54) ONE-TIME-PROGRAMMING SYSTEM OF OFFLINE ELECTRONIC LOCKS AND METHODS OF USING THE SAME

(71) Applicant: NANJING EASTHOUSE ELECTRICAL CO., LTD., NANJING (CN)

(72) Inventors: HAO MIN, NANJING (CN); MIN SHI, ALPHARETTA, GA (US); YUE ZHANG, NANJING (CN)

(73) Assignee: NANJING EASTHOUSE ELECTRICAL CO., LTD., NANJING (CN)

(21) Appl. No.: 18/575,465

(22) PCT Filed: Dec. 25, 2023
(86) PCT No.: PCT/CN2023/141701

§ 371 Date: Dec. 29, 2023

(51) Int. Cl. G07C 9/00

(52) U.S. Cl. CPC G07C 9/00817; G07C 9/00571; G07C 9/00904

(57) ABSTRACT

Present disclosure relates to a portable putting drill system. The portable putting drill system includes a sensor array, a drill data collection circuit, and a mobile electronic device. The sensor array collects putting drill data including a striking speed, striking angle of a putter, and whether putter hits its sweet spot. Drill data collection circuit includes a data collection circuit for receiving the putting drill data collected by the sensor array, a data processing circuit for processing the putting drill data received, a data reporting circuit for reporting results of the putting drill data processed, and a wireless connection circuit for transmitting the results of putting drill data processed to a mobile electronic device wirelessly over a communication network. Mobile electronic device displays processed putting drill data, provides audio output to a user in real time to enhance putting drill experience, and saves historic statistics of putting drill data.

### FIELD

The present disclosure generally relates to offline electronic locks, and more particularly to a one-time-programming server, a one-time-programming system, and methods of using the one-time-programming system.

### BACKGROUND

Currently, an increasing number of electronic locks are being installed and utilized in various banks and commercial retail facilities to replace traditional mechanical locks. There are electrical locks that are connected to a network, while others are not. Management of online electronic locks centralized from a cloud, such as adding/removing users, granting authorizations to users, and changing many lock parameters, is all fairly easy and simple. However, it is still very difficult to manage offline electronic locks. This includes granting authorizations to users, and changing many lock parameters. Companies or banks with branch offices scattered all over the places find these tasks challenging. For example, if a store manager is terminated, a regional manager (or other shift manager) has to travel to the store to remove the ex-manager's access using their personal code, then grant permission/authority to a new manager. When the regional manager is unavailable to perform functions above, the store will have to contact the manufacturer of the locks. Unless the manufacturer sends someone to the store, the manufacturer has to instruct the new manager to delete the old manager's code and add new manager's code using what is known as a super code or master code. This practice should not be allowed because the super code should not be disclosed to any customers.

Currently, there is no easy way to access such electronic locks unless a person from a lock manufacturer or a locksmith travels to the retail store in person to re-program the affected electronic locks. It is costly, and very time-consuming.

It is desirable to provide an easy, secure and remote access to grant a local authorized customer one-time-programming authority to re-program the affected electronic locks without leaking the super code of the lock or requiring customer service providers to travel to the retail store and re-program these affected electronic locks in person.

Therefore, heretofore unaddressed needs still exist in the art to address the aforementioned deficiencies and inadequacies.

### SUMMARY

In one aspect, present disclosure relates to a one-time-programming server designed for one-time-programming for offline electronic locks. In certain embodiments, the one-time-programming server includes: a processor, an equipment database, and a non-volatile memory. The processor manages operations of the one-time-programming server. The equipment database stores information of a group of electronic locks installed across branch offices of various organizations. The non-volatile memory stores an operating system and computer executable instructions. The operating system controls operations of the one-time-programming server. The computer executable instructions include a one-time-programming module for enabling a group of one-time-programming service providers to assist a group of customers to perform one-time-programming. When executed by the processor, the computer executable instructions perform following operations:
receiving, by a one-time-programming service provider, a one-time-programming request over a phone call from a customer when the customer requests one of a set of one-time-programming function types to be performed on an electronic lock;
generating, by the one-time-programming module, a one-time-programming function code for the one-time-programming service provider to inform the customer over the phone call, and the one-time-programming function code includes a first random number, a requested one-time-programming function type, and additional parameters if required for the requested one-time-programming function type;
receiving, by the one-time-programming service provider at the one-time-programming server, a response code after the customer enters the one-time-programming function code received on a keypad of the electronic lock, a lock firmware of the electronic lock internally generates and displays the response code on a lock display screen of the electronic lock, and providing, by the customer, the response code generated to the one-time-programming service provider over the phone call, and the response code generated by the lock firmware of the electronic lock includes: a lock ID of the electronic lock and a second random number;
generating, by the one-time-programming module, a first one-time-programming code using the first random number and the second random number with a predetermined algorithm when the one-time-programming service provider enters the response code received, and providing the first one-time-programming code for the one-time-programming service provider to inform the customer over the phone call, a text message, or an email when the one-time-programming module verifies the lock ID of the electronic lock through the equipment database, and when the customer enters the first one-time-programming code on the keypad of the electronic lock, the lock firmware of the electronic lock internally generates a second one-time-programming code using the first random number and the second random number with the predetermined algorithm, performs the requested one-time-programming function, and prompts the customer to enter optional parameters when the optional parameters are required for certain one-time-programming functions, when the first one-time-programming code received matches the second one-time-programming code generated.

In certain embodiments, the one-time-programming server is deployed in a cloud and is accessible by the group of one-time-programming service providers over a network, and the network includes: a wireless personal area network (WPAN) having a Wi-Fi network, a Bluetooth network, an infrared network, and a Zigbee network, a wired local area network, a wireless local area network, a wireless metropolitan area network (WMAN), a wireless wide area network (WWAN), a cellular network, and a mobile communication network.

In certain embodiments, each of the electronic lock includes: the lock firmware, the lock display screen, the keypad, a menu key, and an OK key. The lock firmware controls operations of the electronic lock. The lock display screen displays various menu items, and the response code generated by the lock firmware. The keypad is used by the customer to enter the one-time-programming function code received and the one-time-programming code. The menu key is used by the customer to select a set of lock functions including one-time-programming function. The OK key is used by the customer to terminate an input to the keypad.

In certain embodiments, the information of set of electronic locks stored in the equipment database includes: various lock IDs of each of the set of electronic locks, and various organization identifiers of each of the set of electronic locks.

In certain embodiments, the set of one-time-programming function types includes: set/cancel time delay, obfuscate code entry, delete all users, enable dual mode, set time delay override user ID, enable manager, dual mode group ID, set ID01 to manager, and reset manager code.

In another aspect, the present disclosure relates to a one-time-programming system for performing one-time-programming on various offline electronic locks. The one-time-programming system includes: a group of one-time-programming service providers, the set of electronic locks, and a one-time-programming server. The one-time-programming server is deployed in a cloud and is accessible by the group of one-time-programming service providers over a network, and the group of one-time-programming service providers assist a group of customers to perform one-time-programming on the set of electronic locks.

In certain embodiments, each of the set of electronic locks includes: a lock firmware, a lock display screen, a keypad, a menu key, and an OK key. The lock firmware controls operations of the electronic lock. The lock display screen displays a set of menu items and a response code generated by the lock firmware. The keypad is used by the customer to enter a one-time-programming function code and a one-time-programming code received by the customer. The menu key is used by the customer to select a set of lock functions including one-time-programming function. The OK key is used by the customer to terminate an input to the keypad.

In certain embodiments, the one-time-programming server includes: a processor, an equipment database, and a non-volatile memory. The processor manages operations of the one-time-programming server. The equipment database stores information of the set of electronic locks installed for a group of branch offices of various of organizations. The information of set of electronic locks in the equipment database includes: lock IDs of each of the set of electronic locks, and various organization identifiers of each of the set of electronic locks.

In certain embodiments, the non-volatile memory stores an operating system and computer executable instructions. The operating system controls operations of the one-time-programming server. The computer executable instructions include a one-time-programming module for enabling the group of one-time-programming service providers to assist the group of customers to perform one-time-programming. When executed by the processor, the computer executable instructions perform following operations:
receiving, by a one-time-programming service provider, a one-time-programming request over a phone call from the customer when the customer requests one of a set of one-time-programming function types to be performed on the electronic lock;
generating, by the one-time-programming module, the one-time-programming function code for the one-time-programming service provider to inform the customer over the phone call;
receiving, by the one-time-programming service provider at the one-time-programming server, the response code after the customer enters the one-time-programming function code received on the keypad of the electronic lock, the lock firmware of the electronic lock internally generates and displays the response code on the lock display screen of the electronic lock, and providing, by the customer, the response code generated to the one-time-programming service provider over the phone call; and
generating, by the one-time-programming module, a first one-time-programming code using a first random number, and a second random number with a predetermined algorithm when the one-time-programming service provider enters the response code received, and providing the first one-time-programming code for the one-time-programming service provider to inform the customer over the phone call, a text message, or an email when the one-time-programming module verifies the lock ID of the electronic lock through the equipment database, and when the customer enters the first one-time-programming code on the keypad of the electronic lock, the lock firmware of the electronic lock internally generates a second one-time-programming code using the first random number and the second random number with the predetermined algorithm, performs the requested one-time-programming function, and prompts the customer to enter optional parameters when the optional parameters are required for certain one-time-programming functions, when the first one-time-programming code received matches the second one-time-programming code generated.

In yet another aspect, the present disclosure relates to a method of performing one-time-programming for offline electronic locks. In certain embodiments, the method includes:
installing, by a system installer, a one-time-programming server in a cloud over a network, and the one-time-programming server is accessible by a group of one-time-programming service providers;
initiating, by a customer via a phone call, a one-time-programming request to a one-time-programming service provider, when the customer requests one of a set of one-time-programming function types on an electronic lock;
generating, by a one-time-programming module of the one-time-programming server, a one-time-programming function code according to a requested one-time-programming function type received, and providing, the one-time-programming function code generated to the customer over the phone call;
entering, by the customer on a keypad of the electronic lock, the one-time-programming function code received, generating and displaying, by a lock firmware of the electronic lock, a response code on a lock display screen of the electronic lock, and providing, by the customer, the response code to the one-time-programming service provider over the phone call;
entering, by the one-time-programming service provider at the one-time-programming server, the response code received after the electronic lock is verified through an equipment database of the one-time-programming server, generating, by the one-time-programming module of the one-time-programming server, a first one-time-programming code, and providing, by the one-time-programming service provider, the first one-time-programming code to the customer via the phone call, a text message, or an email; and
entering, by the customer, the first one-time-programming code received on the keypad of the electronic lock, generating internally, by the lock firmware of the electronic lock, a second one-time-programming code, comparing, by the lock firmware of the electronic lock, the first one-time-programming code received and the second one-time-programming code generated, and when the first one-time-programming code received matches the second one-time-programming code generated, performing, by the lock firmware of the electronic lock, the requested one-time-programming function, and when optional parameters are required for certain one-time-programming functions, the lock firmware of the electronic lock prompts the customer to enter the required optional parameters.

In certain embodiments, each of the set of electronic locks includes: the lock firmware, the lock display screen, the keypad, a menu key, and an OK key. The lock firmware controls operations of the electronic lock. The lock display screen displays a set of menu items and a response code generated by the lock firmware. The keypad is used by the customer to enter a one-time-programming function code and a one-time-programming code received by the customer. The menu key is used by the customer to select a set of lock functions including one-time-programming function. The OK key is used by the customer to terminate an input to the keypad.

In certain embodiments, the one-time-programming function code includes: a first random number, the requested one-time-programming function type, and additional parameters if required for the requested one-time-programming function type.

In certain embodiments, the response code generated by the lock firmware of the electronic lock includes: a lock ID of the electronic lock and a second random number.

In certain embodiments, the first one-time-programming code is generated by the one-time-programming module of the one-time-programming server using the first random number and the second random number with a predetermined algorithm.

In certain embodiments, the second one-time-programming code is generated internally by the lock firmware of the electronic lock using the first random number and the second random number with the predetermined algorithm.

In certain embodiments, the one-time-programming server includes: a processor, the equipment database, and a non-volatile memory. The processor manages operations of the one-time-programming server. The equipment database stores information of a group of electronic locks installed for a group of branch offices of various organizations. The non-volatile memory stores an operating system and computer executable instructions. The operating system controls operations of the one-time-programming server. The computer executable instructions include the one-time-programming module for enabling a group of one-time-programming service providers to assist a group of customers to perform one-time-programming. When executed by the processor, the computer executable instructions perform following operations:
receiving, by a one-time-programming service provider, a one-time-programming request over the phone call from the customer when the customer requests one of a set of one-time-programming function types to be performed on the electronic lock;
generating, by the one-time-programming module, a one-time-programming function code for the one-time-programming service provider to inform the customer over the phone call;
receiving, by the one-time-programming service provider at the one-time-programming server, a response code after the customer enters the one-time-programming function code received on the keypad of the electronic lock, the lock firmware of the electronic lock internally generates and displays the response code on the lock display screen of the electronic lock, and providing, by the customer, the response code generated to the one-time-programming service provider over the phone call; and
generating, by the one-time-programming module, a first one-time-programming code using the first random number and the second random number with the predetermined algorithm when the one-time-programming service provider enters the response code received, and providing the first one-time-programming code for the one-time-programming service provider to inform the customer over the phone call, a text message, or an email when the one-time-programming module verifies the lock ID of the electronic lock through the equipment database, and when the customer enters the first one-time-programming code on the keypad of the electronic lock, the lock firmware of the electronic lock internally generates a second one-time-programming code using the first random number and the second random number with the predetermined algorithm, and performs the requested one-time-programming function, and prompts the customer to enter optional parameters when the optional parameters are required for certain one-time-programming functions, when the first one-time-programming code received matches the second one-time-programming code generated.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the present disclosure, and features and benefits thereof, and together with the written description, serve to explain the principles of the present invention. Wherever possible, the same reference numbers are used throughout the drawings to refer to the same or like elements of an embodiment, and wherein:

FIG. 1 shows a block diagram of a one-time-programming system according to certain embodiments of the present disclosure;

FIG. 2 shows a message flow chart of the one-time-programming system according to certain embodiments of the present disclosure;

FIG. 3 shows a list of one-time-programming function types of the one-time-programming system according to certain embodiments of the present disclosure; and

FIG. 4 shows a method of using the one-time-programming system according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the terms “electronic locks” means “offline electronic locks”.

As used herein, the phrase at least one of A, B, and C should be construed to mean a logical (A or B or C), using a non-exclusive logical OR. It should be understood that one or more steps within a method may be executed in different order (or conventionally) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

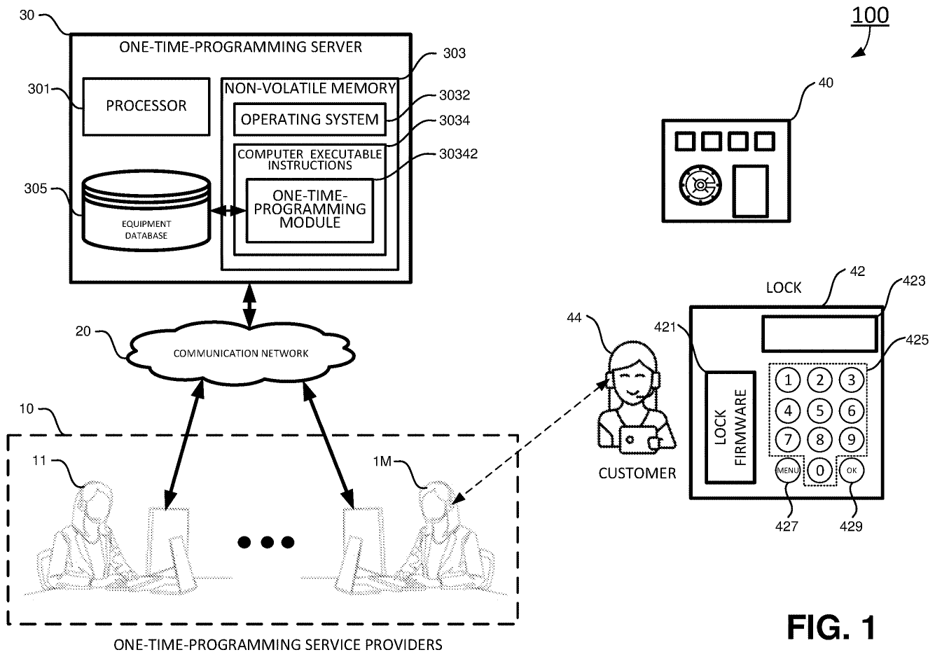

Referring now to FIG. 1, in one aspect, the present disclosure relates to a one-time-programming server 30 for one-time-programming of electronic locks 42. In certain embodiments, the one-time-programming server 30 includes: a processor 301, an equipment database 305, and a non-volatile memory 303. The processor 301 controls operations of the one-time-programming server 30. The equipment database 307 stores information of a group of electronic locks 42 installed for a group of branch offices of various organizations. In certain embodiments, the information of set of electronic locks 42 stored in the equipment database 305 includes: various lock IDs of each of these electronic locks 42, and various organization identifiers of each of the set of electronic locks 42.

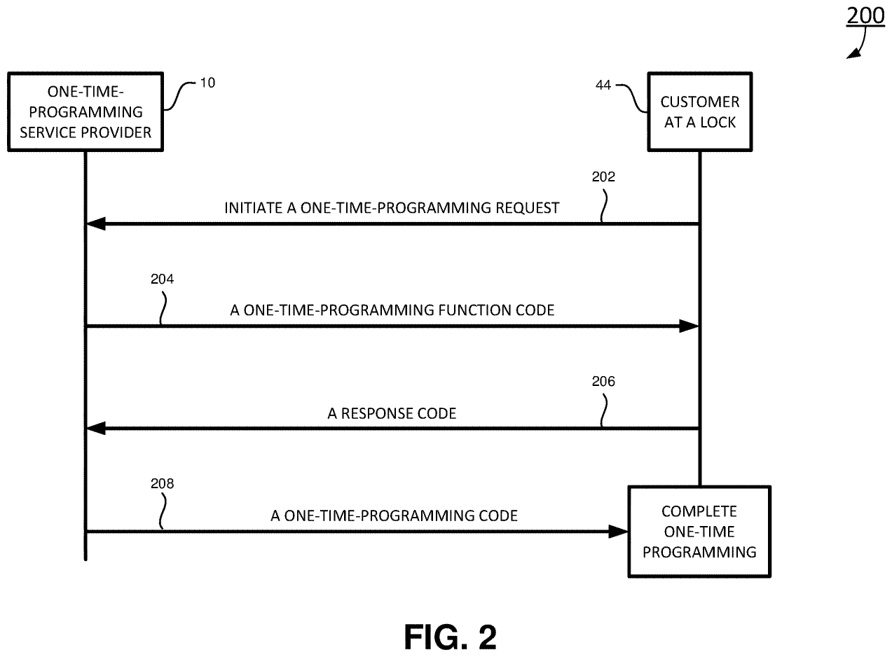

In certain embodiments, the non-volatile memory 303 stores an operating system 3032 and computer executable instructions 3034. The operating system 3032 controls operations of the one-time-programming server 30. The computer executable instructions 3034 include a one-time-programming module 30342 for enabling a group of one-time-programming service providers 10 to assist a group of customers 44 to perform one-time-programming on various electronic locks 42. When executed by the processor 301, as shown in FIG. 2, the computer executable instructions 3034 perform following operations:
receiving, by a one-time-programming service provider 10, a one-time-programming request over a phone call from the customer 44 when the customer 44 requests one of a set of one-time-programming function types to be performed on the electronic lock 42;
generating, by the one-time-programming module 30342, a one-time-programming function code for the one-time-programming service provider 10 to inform the customer 44 over the phone call. The one-time-programming function code includes: a first random number, a requested one-time-programming function type, and additional parameters if required for the requested one-time-programming function type;
receiving, by the one-time-programming service provider 10 at the one-time-programming server 30, a response code after the customer 44 enters the one-time-programming function code received on a keypad 425 of the electronic lock 42, a lock firmware 421 of the electronic lock 42 internally generates and displays the response code on a lock display screen 423 of the electronic lock 42, and providing, by the customer 44, the response code generated to the one-time-programming service provider 10 over the phone call; and
generating, by the one-time-programming module 30342, a first one-time-programming code using the first random number and the second random number with a predetermined algorithm when the one-time-programming service provider 10 enters the response code received, and providing the first one-time-programming code for the one-time-programming service provider 10 to inform the customer 44 over the phone call, a text message, or an email when the one-time-programming module 30342 verifies the lock ID of the electronic lock 42 through the equipment database 305, and when the customer 44 enters the first one-time-programming code on the keypad 425 of the electronic lock 42, the lock firmware 421 of the electronic lock 42 internally generates a second one-time-programming code using the first random number and the second random number with the predetermined algorithm, performs the requested one-time-programming function, and prompts the customer 44 to enter optional parameters when the optional parameters are required for certain one-time-programming functions, when the first one-time-programming code received matches the second one-time-programming code generated.

In certain embodiments, each of the electronic lock 42 includes: the lock firmware 421, the lock display screen 423, the keypad 425, a menu key 427, and an OK key 429. The lock firmware 421 controls operations of the electronic lock 42. The lock display screen 423 displays various menu items, and the response code generated by the lock firmware 421. The keypad 425 is used by the customer 44 to enter the one-time-programming function code received and the one-time-programming code. The menu key 427 is used by the customer 44 to select a set of lock functions including one-time-programming function. The OK key 429 is used by the customer 44 to terminate an input to the keypad 425.

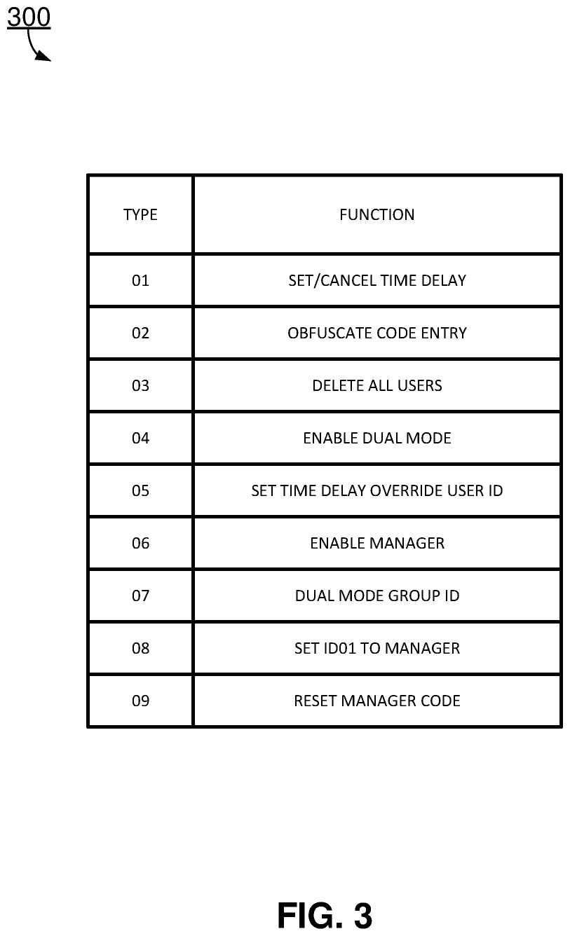

In certain embodiments, as shown in FIG. 3, the set of one-time-programming function types includes: set/cancel time delay, obfuscate code entry, delete all users, enable dual mode, set time delay override user ID, enable manager, dual mode group ID, set ID01 to manager, and reset manager code.

In certain embodiments, the one-time-programming function code includes: the first random number, the requested one-time-programming function type, and additional parameters if required for the requested one-time-programming function type. In certain embodiments, the first random number is generated by the one-time-programming server 30 based on the current time, so that the first random number will be guaranteed to be unique and different each time the first random number is generated.

In certain embodiments, for certain requested one-time-programming function types, optional parameters may be required. For example, when the customer 44 requests one-time-programming function type: “set/cancel time delay”, the one-time-programming function code may include the function code of “set time delay” and an additional parameter of the time delay, for example, 10 minutes. The additional parameter of the time delay is preset by the one-time-programming server 30 and passed down to the customer 44 through the one-time-programming function code. Therefore, the one-time-programming function code sent to the customer 44 really means “set time delay to 10 minutes”. If the additional value of the time delay is sent as 0, then, the one-time-programming function code really means “set time delay to 0 minute”, or “cancel time delay”. The time delay is for security purpose so that when “set time delay” is enabled by the one-time-programming server 30, and when the customer 44 uses his/her personal code to unlock the electronic lock 42, the electronic lock 42 will be unlocked after the “10 minutes” time delay.

In certain embodiments, the response code generated by the lock firmware 421 of the electronic lock 42 includes: a lock ID of the electronic lock 42 and a second random number. The lock ID of the requesting electronic lock 42 sent is used by the one-time-programming service provider 10 to verify the identity of the electronic lock 42, by checking the lock IDs of electronic locks 42 stored in the equipment database 305. The second random number is generated by the lock firmware 421 of the electronic lock 42 based on the current time, so that the second random number will be guaranteed to be unique and different each time the second random number is generated.

Once the response code from the customer 44 is received by the one-time-programming service provider 10, and entered into the one-time-programming server 30, the one-time-programming module 30342 of the one-time-programming server 30 generates and display a first one-time-programming code to the one-time-programming service provider 10. The first one-time-programming code is generated using the first random number and the second random number with a predetermined algorithm and the first one-time-programming code is provided to the customer 44 over the phone call, a text message, or an email.

Once the customer 44 sends the response code to the one-time-programming service provider 10 over the phone call, the lock firmware 421 of the electronic lock 42 also generates a second one-time-programming code. The second one-time-programming code is generated using the first random number and the second random number with the predetermined algorithm.

After the customer 44 receives the first one-time-programming code, and enters the first one-time-programming code in the keypad 425 of the electronic lock 42, the lock firmware 421 of the electronic lock 42 compares the first one-time-programming code received and the second one-time-programming code generated. When the first one-time-programming code received matches the second one-time-programming code generated, the firmware 421 of the electronic lock 42 performs the requested one-time-programming function, and prompts the customer 44 to enter optional parameters when the optional parameters are required for certain one-time-programming functions. For example, when the requested one-time-programming function is “reset manager code”, the lock display screen 423 of the electronic lock 42 prompts the customer 44 to enter a new personal code for the manager. Here, the optional parameter required is the new personal code for the manager. Certain one-time-programming function types such as “obfuscate code entry”, “delete all users”, “enable manager”, and “set ID01 to manager” do not require any optional parameters. So once the customer 44 enters the first one-time-programming code on the keypad 425, and when the first one-time-programming code received matches the second one-time-programming code generated, the firmware 421 of the electronic lock 42 will perform requested one-time-programming function and the one-time-programming of the electronic lock 42 is completed.

In certain embodiments, there are a few preset user IDs in the electronic lock 42, such as ID01, ID02, . . . and ID0N. If these user IDs are not set as manager, then they all have basic right to access the electronic lock 42. Once an ID0X is set as manager, then the user will be able to perform certain functions as manager, such as add a user, remove a user, set a user's personal code, and set a user as manager etc.

In certain embodiments, the one-time-programming server 30 is deployed in a cloud and is accessible by the group of one-time-programming service providers 10 over a network 20. The network 20 includes: a wireless personal area network (WPAN) having a Wi-Fi network, a Bluetooth network, an infrared network, and a Zigbee network, a wired local area network, a wireless local area network, a wireless metropolitan area network (WMAN), a wireless wide area network (WWAN), a cellular network, and a mobile communication network.

In another aspect, the present disclosure relates to a one-time-programming system 100 for performing one-time-programming on various offline electronic locks 42. The one-time-programming system 100 includes: a group of one-time-programming service providers 10, a set of electronic locks 42, and a one-time-programming server 30. The one-time-programming server 30 is deployed in a cloud and is accessible by the group of one-time-programming service providers 10 over a network 20, and the group of one-time-programming service providers 10 assist a group of customers 44 to perform one-time-programming on the set of electronic locks 42.

In certain embodiments, as shown in FIG. 1, each of the set of electronic locks 42 includes: a lock firmware 421, a lock display screen 423, a keypad 425, a menu key 427, and an OK key 429. The lock firmware 421 controls operations of the electronic lock 42. The lock display screen 423 displays a set of menu items and a response code generated by the lock firmware 421. The keypad 425 is used by the customer 44 to enter a one-time-programming function code and a one-time-programming code received by the customer 44. The menu key 427 is used by the customer 44 to select a set of lock functions including one-time-programming function. The OK key 429 is used by the customer 44 to terminate an input to the keypad 425.

In certain embodiments, the one-time-programming server 30 includes: a processor 301, an equipment database 305, and a non-volatile memory 303. The processor 301 controls operations of the one-time-programming server 30. The equipment database 307 stores information of the set of electronic locks 42 installed for a group of branch offices of various of organizations. The information of set of electronic locks 42 in the equipment database 305 includes: lock IDs of each of the set of electronic locks 42, and various organization identifiers of each of the set of electronic locks 42.

In certain embodiments, the non-volatile memory 303 stores an operating system 3032 and computer executable instructions 3034. The operating system 3032 controls operations of the one-time-programming server 30. The computer executable instructions 3034 include a one-time-programming module 30342 for enabling the group of one-time-programming service providers 10 to assist the group of customers 44 to perform one-time-programming on the set of electronic locks 42. When executed by the processor 301, as shown in FIG. 2, the computer executable instructions 3034 perform following operations:
receiving, by a one-time-programming service provider 10, a one-time-programming request over a phone call from the customer 44 when the customer 44 requests one of a set of one-time-programming function types to be performed on the electronic lock 42.
generating, by the one-time-programming module 30342, the one-time-programming function code for the one-time-programming service provider 10 to inform the customer 44 over the phone call. The one-time-programming function code includes: a first random number, a requested one-time-programming function type, and additional parameters if required for the requested one-time-programming function type.
receiving, by the one-time-programming service provider 10 at the one-time-programming server 30, the response code after the customer 44 enters the one-time-programming function code received on the keypad 425 of the electronic lock 42, the lock firmware 421 of the electronic lock 42 internally generates and displays the response code on the lock display screen 423 of the electronic lock 42, and providing, by the customer 44, the response code generated to the one-time-programming service provider 10 over the phone call; and
generating, by the one-time-programming module 30342, a first one-time-programming code using the first random number, and a second random number with a predetermined algorithm when the one-time-programming service provider 10 enters the response code received, and providing the first one-time-programming code for the one-time-programming service provider 10 to inform the customer 44 over the phone call, a text message, or an email when the one-time-programming module 30342 verifies the lock ID of the electronic lock 42 through the equipment database 305, and when the customer 44 enters the first one-time-programming code on the keypad 425 of the electronic lock 42, the lock firmware 421 of the electronic lock 42 internally generates a second one-time-programming code using the first random number and the second random number with the predetermined algorithm, performs the requested one-time-programming function, and prompts the customer 44 to enter optional parameters when the optional parameters are required for certain one-time-programming functions, when the first one-time-programming code received matches the second one-time-programming code generated.

In certain embodiments, the set of one-time-programming function types includes: set/cancel time delay, obfuscate code entry, delete all users, enable dual mode, set time delay override user ID, enable manager, dual mode group ID, set ID01 to manager, and reset manager code.

In yet another aspect, the present disclosure relates to a method of performing one-time-programming for offline electronic locks 42. In certain embodiments, the method includes:
installing, by a system installer, a one-time-programming server 30 in a cloud over a network, and the one-time-programming server 30 is accessible by a group of one-time-programming service providers 10;
initiating, by a customer 44 via a phone call, a one-time-programming request to a one-time-programming service provider 10, when the customer 44 requests one of a set of one-time-programming function types on an electronic lock 42;
generating, by a one-time-programming module 30342 of the one-time-programming server 30, a one-time-programming function code according to a requested one-time-programming function type received, and providing, the one-time-programming function code generated to the customer 44 over the phone call;
entering, by the customer 44 on a keypad 425 of the electronic lock 42, the one-time-programming function code received, generating and displaying, by a lock firmware 421 of the electronic lock 42, a response code on a lock display screen 423 of the electronic lock 42, and providing, by the customer 44, the response code to the one-time-programming service provider 10 over the phone call;
entering, by the one-time-programming service provider 10 at the one-time-programming server 30, the response code received after the electronic lock 42 is verified through an equipment database 305 of the one-time-programming server 30, generating, by the one-time-programming module 30342 of the one-time-programming server 30, a first one-time-programming code, and providing, by the one-time-programming service provider 10, the first one-time-programming code to the customer 44 via the phone call, a text message, or an email; and
entering, by the customer 44, the first one-time-programming code received on the keypad 425 of the electronic lock 42, generating internally, by the lock firmware 421 of the electronic lock 42, a second one-time-programming code, comparing, by the lock firmware 421 of the electronic lock 42, the first one-time-programming code received and the second one-time-programming code generated, and when the first one-time-programming code received matches the second one-time-programming code generated, performing, by the lock firmware 421 of the electronic lock 42, the requested one-time-programming function, and when optional parameters are required for certain one-time-programming functions, the lock firmware 421 of the electronic lock 42 prompts the customer 44 to enter the required optional parameters.

In certain embodiments, as shown in FIG. 1, each of the set of electronic locks 42 includes: the lock firmware 421, the lock display screen 423, the keypad 425, a menu key 427, and an OK key 429. The lock firmware 421 controls operations of the electronic lock 42. The lock display screen 423 displays a set of menu items and a response code generated by the lock firmware 421. The keypad 425 is used by the customer 44 to enter a one-time-programming function code and a one-time-programming code received by the customer 44. The menu key 427 is used by the customer 44 to select a set of lock functions including one-time-programming function. The OK key 429 is used by the customer 44 to terminate an input to the keypad 425.

In certain embodiments, the one-time-programming function code includes: a first random number, the requested one-time-programming function type, and additional parameters if required for the requested one-time-programming function type.

In certain embodiments, the response code generated by the lock firmware 421 of the electronic lock 42 includes: a lock ID of the electronic lock 42 and a second random number.

In certain embodiments, the first one-time-programming code is generated by the one-time-programming module 30342 of the one-time-programming server 30 using the first random number and the second random number with a predetermined algorithm.

In certain embodiments, the second one-time-programming code is generated internally by the lock firmware 421 of the electronic lock 42 using the first random number and the second random number with the predetermined algorithm.

In certain embodiments, the one-time-programming server 30 includes: a processor 301, the equipment database 305, and a non-volatile memory 303. The processor 301 controls operations of the one-time-programming server 30. The equipment database 307 stores information of a group of electronic locks 42 installed for a group of branch offices of various organizations. The non-volatile memory 303 stores an operating system 3032 and computer executable instructions 3034. The operating system 3032 controls operations of the one-time-programming server 30. The computer executable instructions 3034 include a one-time-programming module 30342 for enabling a group of one-time-programming service providers 10 to assist a group of customers 44 to perform one-time-programming. When executed by the processor 301, as shown in FIG. 2, the computer executable instructions 3034 perform following operations:
receiving, by a one-time-programming service provider 10, a one-time-programming request over the phone call from the customer 44 when the customer 44 requests one of a set of one-time-programming function types to be performed on the electronic lock 42;
generating, by the one-time-programming module 30342, a one-time-programming function code for the one-time-programming service provider 10 to inform the customer 44 over the phone call;
receiving, by the one-time-programming service provider 10 at the one-time-programming server 30, a response code after the customer 44 enters the one-time-programming function code received on the keypad 425 of the electronic lock 42, the lock firmware 421 of the electronic lock 42 internally generates and displays the response code on the lock display screen 423 of the electronic lock 42, and providing, by the customer 44, the response code generated to the one-time-programming service provider 10 over the phone call; and
generating, by the one-time-programming module 30342, a first one-time-programming code using the first random number and the second random number with the predetermined algorithm when the one-time-programming service provider 10 enters the response code received, and providing the first one-time-programming code for the one-time-programming service provider 10 to inform the customer 44 over the phone call, a text message, or an email when the one-time-programming module 30342 verifies the lock ID of the electronic lock 42 through the equipment database 305, and when the customer 44 enters the first one-time-programming code on the keypad 425 of the electronic lock 42, the lock firmware 421 of the electronic lock 42 internally generates a second one-time-programming code using the first random number and the second random number with the predetermined algorithm, and performs the requested one-time-programming function, and prompts the customer 44 to enter optional parameters when the optional parameters are required for certain one-time-programming functions, when the first one-time-programming code received matches the second one-time-programming code generated.

In certain embodiments, the network 20 includes: a wireless personal area network (WPAN) having a Wi-Fi network, a Bluetooth network, an infrared network, and a Zigbee network, a wired local area network, a wireless local area network, a wireless metropolitan area network (WMAN), a wireless wide area network (WWAN), a cellular network, and a mobile communication network.

In certain embodiments, the information of set of electronic locks 42 stored in the equipment database 305 includes: various lock IDs of each of the set of electronic locks 42, and various organization identifiers of each of the set of electronic locks 42.

In certain embodiments, the set of one-time-programming function types includes: set/cancel time delay, obfuscate code entry, delete all users, enable dual mode, set time delay override user ID, enable manager, dual mode group ID, set ID01 to manager, and reset manager code.

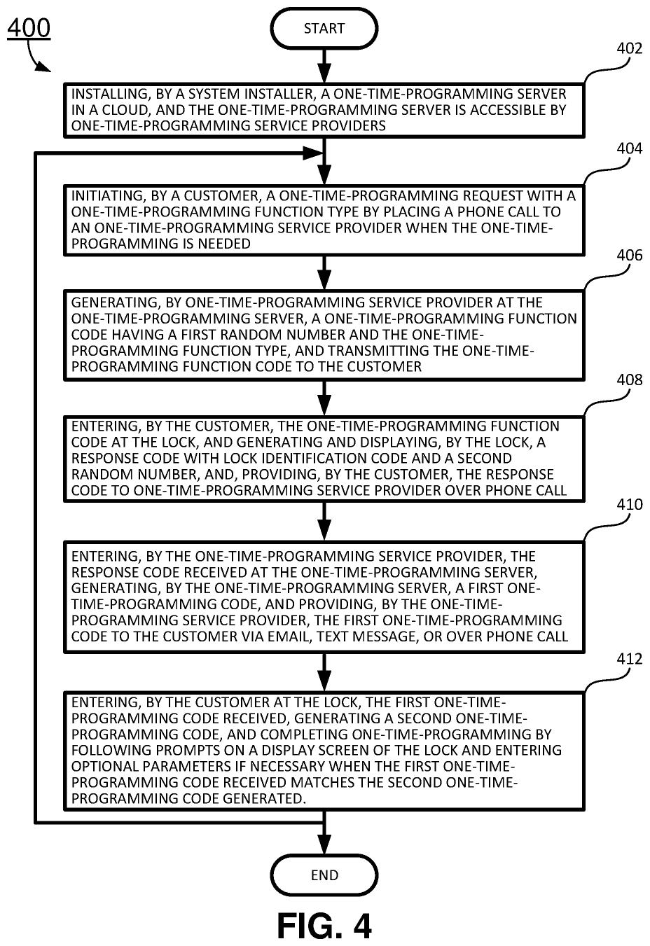

Referring now to FIG. 4, a method 400 of using the one-time-programming system 100 is shown according to certain embodiments of the present disclosure.

At block 402, a system installer installs a one-time-programming server 30 in a cloud over a network. The one-time-programming server 30 is accessible by a group of one-time-programming service providers 10 to assist a group of customers 44 to perform one-time-programming of a set of electronic locks 42;

At block 404, when a customer 44 requests one of a set of one-time-programming function types to be performed on an electronic lock 42, the customer 44 place a phone call to a one-time-programming service provider 10 to initiate a one-time-programming request. The customer 44 informs the one-time-programming service provider 10 a requested one-time-programming function type, as shown in FIG. 3, over the phone call.

At block 406, a one-time-programming module 30342 of the one-time-programming server 30 generates a one-time-programming function code according to the requested one-time-programming function type received, and the one-time-programming service provider 10 provides the one-time-programming function code generated to the customer 44 over the phone call.

In certain embodiments, the one-time-programming function code includes: a first random number, the requested one-time-programming function type, and additional parameters if required for the requested one-time-programming function type.

At block 408, the customer 44 enters the one-time-programming function code received on a keypad 425 of the electronic lock 42. A lock firmware 421 of the electronic lock 42 generates and displays a response code on a lock display screen 423 of the electronic lock 42. The customer 44 provides the response code to the one-time-programming service provider 10 over the phone call. In certain embodiments, the response code generated by the lock firmware 421 of the electronic lock 42 includes: a lock ID of the electronic lock 42 and a second random number.

At block 410, the one-time-programming service provider 10 enters the response code received at the one-time-programming server 30 and the one-time-programming server 30 verifies the authenticity of the electronic lock 42 through an equipment database 305 of the one-time-programming server 30. The one-time-programming module 30342 of the one-time-programming server 30 generates a first one-time-programming code, and the one-time-programming service provider 10 provides the first one-time-programming code to the customer 44 via the phone call, a text message, or an email. The first one-time-programming code is generated using the first random number and the second random number with the predetermined algorithm

At block 412, the customer 44 enters the first one-time-programming code received on the keypad 425 of the electronic lock 42. The lock firmware 421 of the electronic lock 42 generates internally a second one-time-programming code. The second one-time-programming code is generated internally using the first random number and the second random number with the predetermined algorithm.

In certain embodiments, the lock firmware 421 of the electronic lock 42 compares the first one-time-programming code received and the second one-time-programming code generated. When the first one-time-programming code received matches the second one-time-programming code generated, the lock firmware 421 of the electronic lock 42 performs the requested one-time-programming function. When optional parameters are required for certain one-time-programming function types, the lock firmware 421 of the electronic lock 42 prompts the customer 44 to enter the required optional parameters on the keypad 425.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. A one-time-programming server, comprising:
a processor, wherein the processor manages operations of the one-time-programming server;
an equipment database, wherein the equipment database stores information of a plurality of electronic locks installed for a plurality of branch offices of a plurality of organizations; and
a non-volatile memory, wherein the non-volatile memory stores an operating system and computer executable instructions, the operating system controls operations of the one-time-programming server, and the computer executable instructions include a one-time-programming module for enabling a plurality of one-time-programming service providers to assist a plurality of customers to perform one-time-programming, when executed by the processor, the computer executable instructions perform following operations:
receiving, by a one-time-programming service provider, a one-time-programming request over a phone call from a customer when the customer requests one of a plurality of one-time-programming function types to be performed on an electronic lock;
generating, by the one-time-programming module, a one-time-programming function code for the one-time-programming service provider to inform the customer over the phone call, wherein the one-time-programming function code includes: a first random number, a requested one-time-programming function type, and additional parameters if required for the requested one-time-programming function type;
receiving, by the one-time-programming service provider at the one-time-programming server, a response code after the customer enters the one-time-programming function code received on a keypad of the electronic lock, a lock firmware of the electronic lock internally generates and displays the response code on a lock display screen of the electronic lock, and providing, by the customer, the response code generated to the one-time-programming service provider over the phone call, wherein the response code generated by the lock firmware of the electronic lock includes: a lock ID of the electronic lock and a second random number;
generating, by the one-time-programming module, a first one-time-programming code using the first random number and the second random number with a predetermined algorithm when the one-time-programming service provider enters the response code received, and providing the first one-time-programming code for the one-time-programming service provider to inform the customer over the phone call, a text message, or an email when the one-time-programming module verifies the lock ID of the electronic lock through the equipment database, wherein when the customer enters the first one-time-programming code on the keypad of the electronic lock, the lock firmware of the electronic lock internally generates a second one-time-programming code using the first random number and the second random number with the predetermined algorithm, performs the requested one-time-programming function, and prompts the customer to enter optional parameters when the optional parameters are required for certain one-time-programming functions, when the first one-time-programming code matches the second one-time-programming code.

2. The one-time-programming server according to claim 1, wherein the one-time-programming server is deployed in a cloud and is accessible over a network, and wherein the network comprises a wireless personal area network (WPAN) having a Wi-Fi network, a Bluetooth network, an infrared network, and a Zigbee network, a wired local area network, a wireless local area network, a wireless metropolitan area network (WMAN), a wireless wide area network (WWAN), a cellular network, and a mobile communication network.

3. The one-time-programming server according to claim 1, wherein each of the plurality of electronic locks comprises:
the lock firmware, wherein the lock firmware controls operations of the electronic lock;
the lock display screen, wherein the lock display screen displays a plurality of menu items, and the response code generated by the lock firmware;
the keypad, wherein the keypad is used by the customer to enter the one-time-programming function code received, and the one-time-programming code;
a menu key, wherein the menu key is used by the customer to select a plurality of lock functions including one-time-programming function; and
an OK key, wherein the OK key is used by the customer to terminate an input to the keypad.

4. The one-time-programming server according to claim 3, wherein the information of plurality of electronic locks stored in the equipment database comprises:
lock IDs of each of the plurality of electronic locks; and
organization identifiers of each of the plurality of electronic locks.

5. The one-time-programming server according to claim 4, wherein the plurality of one-time-programming function types comprises:
set/cancel time delay;
obfuscate code entry;
delete all users;
enable dual mode;
set time delay override user ID;
enable manager;
dual mode group ID;
set ID01 to manager; and
reset manager code.

6. A one-time-programming system, comprising:
a plurality of one-time-programming service providers;
a one-time-programming server, wherein the one-time-programming server is deployed in a cloud and is accessible over a network by the plurality of one-time-programming service providers to assist a plurality of customers to perform one-time-programming on a plurality of electronic locks, and
the plurality of electronic locks, wherein each of the plurality of electronic locks comprises:
a lock firmware, wherein the lock firmware controls operations of the electronic lock;
a lock display screen, wherein the lock display screen displays a plurality of menu items, and a response code generated by the lock firmware;
a keypad, wherein the keypad is used by the customer to enter a one-time-programming function code and a one-time-programming code received by the customer;
a menu key, wherein the menu key is used by the customer to select a plurality of lock functions including one-time-programming function; and
an OK key, wherein the OK key is used by the customer to terminate an input to the keypad.

7. The one-time-programming system according to claim 6, wherein the one-time-programming server comprises:
a processor, wherein the processor manages operations of the one-time-programming server;
an equipment database, wherein the equipment database stores information of the plurality of electronic locks installed for a plurality of branch offices of a plurality of organizations; and
a non-volatile memory, wherein the non-volatile memory stores an operating system and computer executable instructions, the operating system controls operations of the one-time-programming server, and the computer executable instructions include a one-time-programming module for enabling the plurality of one-time-programming service providers to assist the plurality of customers to perform one-time-programming, when executed by the processor, the computer executable instructions perform following operations:
receiving, by a one-time-programming service provider, a one-time-programming request over a phone call from the customer when the customer requests one of a plurality of one-time-programming function types to be performed on the electronic lock;
generating, by the one-time-programming module, the one-time-programming function code for the one-time-programming service provider to inform the customer over the phone call;
receiving, by the one-time-programming service provider at the one-time-programming server, the response code after the customer enters the one-time-programming function code received on the keypad of the electronic lock, the lock firmware of the electronic lock internally generates and displays the response code on the lock display screen of the electronic lock, and providing, by the customer, the response code generated to the one-time-programming service provider over the phone call; and
generating, by the one-time-programming module, a first one-time-programming code using a first random number, and a second random number with a predetermined algorithm when the one-time-programming service provider enters the response code received, and providing the first one-time-programming code for the one-time-programming service provider to inform the customer over the phone call, a text message, or an email when the one-time-programming module verifies the lock ID of the electronic lock through the equipment database, wherein when the customer enters the first one-time-programming code on the keypad of the electronic lock, the lock firmware of the electronic lock internally generates a second one-time-programming code using the first random number and the second random number with the predetermined algorithm, and performs the requested one-time-programming function, and prompts the customer to enter optional parameters when the optional parameters are required for certain one-time-programming functions, when the first one-time-programming code matches the second one-time-programming code.

8. The one-time-programming system according to claim 7, wherein the network comprises a wireless personal area network (WPAN) having a Wi-Fi network, a Bluetooth network, an infrared network, and a Zigbee network, a wired local area network, a wireless local area network, a wireless metropolitan area network (WMAN), a wireless wide area network (WWAN), a cellular network, and a mobile communication network.

9. The one-time-programming system according to claim 8, wherein the information of plurality of electronic locks in the equipment database comprises:
lock IDs of each of the plurality of electronic locks; and
organization identifiers of each of the plurality of electronic locks.

10. The one-time-programming system according to claim 9, wherein the plurality of one-time-programming function types comprises:
set/cancel time delay;
obfuscate code entry;
delete all users;
enable dual mode;
set time delay override user ID;
enable manager;
dual mode group ID;
set ID01 to manager; and
reset manager code.

11. A method of performing one-time-programming on offline electronic locks, comprising:
installing, by a system installer, a one-time-programming server in a cloud over a network, wherein the one-time-programming server is accessible by a plurality of one-time-programming service providers;
initiating, by a customer via a phone call, a one-time-programming request to a one-time-programming service provider, when the customer requests one of a plurality of one-time-programming function types on an electronic lock;
generating, by a one-time-programming module of the one-time-programming server, a one-time-programming function code according to a requested one-time-programming function type received, and providing the one-time-programming function code generated to the customer over the phone call;
entering, by the customer on a keypad of the electronic lock, the one-time-programming function code received, generating and displaying, by a lock firmware of the electronic lock, a response code on a lock display screen of the electronic lock, and providing, by the customer, the response code to the one-time-programming service provider over the phone call;
entering, by the one-time-programming service provider at the one-time-programming server, the response code received after the electronic lock is verified through an equipment database of the one-time-programming server, generating, by the one-time-programming module of the one-time-programming server, a first one-time-programming code, and providing, by the one-time-programming service provider, the first one-time-programming code to the customer via the phone call, a text message, or an email; and
entering, by the customer, the first one-time-programming code received on the keypad of the electronic lock, generating internally, by the lock firmware of the electronic lock, a second one-time-programming code, comparing, by the lock firmware of the electronic lock, the first one-time-programming code received and the second one-time-programming code generated, and when the first one-time-programming code received matches the second one-time-programming code generated, performing, by the lock firmware of the electronic lock, the requested one-time-programming function, and when optional parameters are required for certain one-time-programming functions, the lock firmware of the electronic lock prompts the customer to enter the required optional parameters.

12. The method of claim 11, wherein each of the plurality of electronic locks comprises:
the lock firmware, wherein the lock firmware controls operations of the electronic lock;
the lock display screen, wherein the lock display screen displays a plurality of menu items, and the response code generated by the lock firmware;
the keypad, wherein the keypad is used by the customer to enter a one-time-programming function code and a one-time-programming code received by the customer;
a menu key, wherein the menu key is used by the customer to select a plurality of lock functions including one-time-programming function; and
an OK key, wherein the OK key is used by the customer to terminate an input to the keypad.

13. The method of claim 12, wherein the one-time-programming function code comprises a first random number, the requested one-time-programming function type, and additional parameters if required for the requested one-time-programming function type.

14. The method of claim 13, wherein the response code generated by the lock firmware of the electronic lock comprises: a lock ID of the electronic lock and a second random number.

15. The method of claim 14, wherein the first one-time-programming code is generated by the one-time-programming module of the one-time-programming server using the first random number and the second random number with a predetermined algorithm.

16. The method of claim 15, wherein the second one-time-programming code is generated by the lock firmware of the electronic lock using the first random number and the second random number with the predetermined algorithm.

17. The method of claim 16, wherein the one-time-programming server comprises:
a processor, wherein the processor manages operations of the one-time-programming server;
the equipment database, wherein the equipment database stores information of a plurality of electronic locks installed for a plurality of branch offices of a plurality of organizations; and
a non-volatile memory, wherein the non-volatile memory stores an operating system and computer executable instructions, the operating system controls operations of the one-time-programming server, and the computer executable instructions include the one-time-programming module for enabling the plurality of one-time-programming service providers to assist a plurality of customers to perform one-time-programming, when executed by the processor, the computer executable instructions perform following operations:
receiving, by a one-time-programming service provider, a one-time-programming request over the phone call from the customer when the customer requests one of the plurality of one-time-programming function types to be performed on the electronic lock;
generating, by the one-time-programming module, a one-time-programming function code for the one-time-programming service provider to inform the customer over the phone call;
receiving, by the one-time-programming service provider at the one-time-programming server, the response code after the customer enters the one-time-programming function code received on the keypad of the electronic lock, the lock firmware of the electronic lock internally generates and displays the response code on the lock display screen of the electronic lock, and providing, by the customer, the response code generated to the one-time-programming service provider over the phone call; and
generating, by the one-time-programming module, a first one-time-programming code using the first random number and the second random number with the predetermined algorithm when the one-time-programming service provider enters the response code received, and providing the first one-time-programming code for the one-time-programming service provider to inform the customer over the phone call, a text message, or an email when the one-time-programming module verifies the lock ID of the electronic lock through the equipment database, wherein when the customer enters the first one-time-programming code on the keypad of the electronic lock, the lock firmware of the electronic lock internally generates a second one-time-programming code using the first random number and the second random number with the predetermined algorithm, and performs the requested one-time-programming function, and prompts the customer to enter optional parameters when the optional parameters are required for certain one-time-programming functions, when the first one-time-programming code matches the second one-time-programming code.

18. The method of claim 11, wherein the network comprises a wireless personal area network (WPAN) having a Wi-Fi network, a Bluetooth network, an infrared network, and a Zigbee network, a wired local area network, a wireless local area network, a wireless metropolitan area network (WMAN), a wireless wide area network (WWAN), a cellular network, and a mobile communication network.

19. The method of claim 11, wherein the information of plurality of electronic locks in the equipment database comprises:
lock IDs of each of the plurality of electronic locks; and
organization identifiers of each of the plurality of electronic locks.

20. The method of claim 11, wherein the plurality of one-time-programming function types comprises:
set/cancel time delay;
obfuscate code entry;
delete all users;
enable dual mode;
set time delay override user ID;
enable manager;
dual mode group ID;
set ID01 to manager; and
reset manager code.
